(19) United States
(12) Patent Application Publication
(10) Pub. No.: US 2012/0111635 A1
(43) Pub. Date: May 10, 2012

(54) Sample Encapsulation and Cache Device and Methods

(76) Inventors: George Caffell, Moss Beach, CA (US); David J. Levitt, San Anselmo, CA (US)

(21) Appl. No.: 13/084,668

(22) Filed: Apr. 12, 2011

Related U.S. Application Data
(60) Provisional application No. 61/323,435, filed on Apr. 13, 2010.

(51) Int. Cl. E21B 49/02; E21B 10/02; H05B 1/00; E21B 25/08

(52) U.S. Cl. 175/58; 175/226; 175/403; 219/209

(57) ABSTRACT

The present invention relates to the field of rock and soil core sampling and more specifically to the preservation of core sample integrity. A sample capsule is described which comprises heat shrink tubing. The sample capsule is located inside a sampling tool such as a core drill bit and activated by electric film heaters also inside the drill bit. A sample capsule front end cap may also be included. A cache mechanism is described which may store one or more sample capsules and front end caps.

### REFERENCE TO RELATED APPLICATIONS

The present application claims priority to U.S. Provisional Application No. 61/323,435 filed Apr. 13, 2010 which is incorporated by reference herein in its entirety.

### FIELD OF THE INVENTION

The present invention relates to the field of rock and soil core sampling and more specifically to the preservation of core sample integrity.

### BACKGROUND OF THE INVENTION

Rock and soil core samples are typically extracted using a core drill and a hollow cylindrical coring bit. Samples are removed from the bit and placed in a sample tube for preservation of properties including but not limited to stratigraphy, volatiles and voids. Various methods of preserving sample core integrity are available which include integrity-preserving sample tubes and encapsulation by an epoxy resin or thermoplastic. With Autonomous drilling applications and especially robotic planetary exploration it is advantageous for samples to be preserved while still inside the core bit.

### BRIEF DESCRIPTION OF THE DRAWINGS

In the attached figures various embodiments are illustrated by way of example. Like reference numerals refer to similar elements.

FIG. 1 illustrates a typical sampling tool an example of which is a core drill bit.

FIG. 2 illustrates an embodiment of the invention comprising a sample capsule located inside a core drill bit.

FIG. 3 is an embodiment of the sample capsule comprising heat shrink tubing with a closed rear end.

FIG. 4 is an embodiment of the sample capsule comprising a rear end cap.

FIG. 5 is an embodiment of the sample capsule comprising heat shrink tubing and heating elements bonded to the heat shrink tubing.

FIG. 6 is an embodiment of the invention comprising a sample capsule and a front end cap.

FIG. 7 is an embodiment of the invention comprising a sample cache.

FIG. 8 is a cutaway of an embodiment of the invention comprising a sample cache.

### DETAILED DESCRIPTION

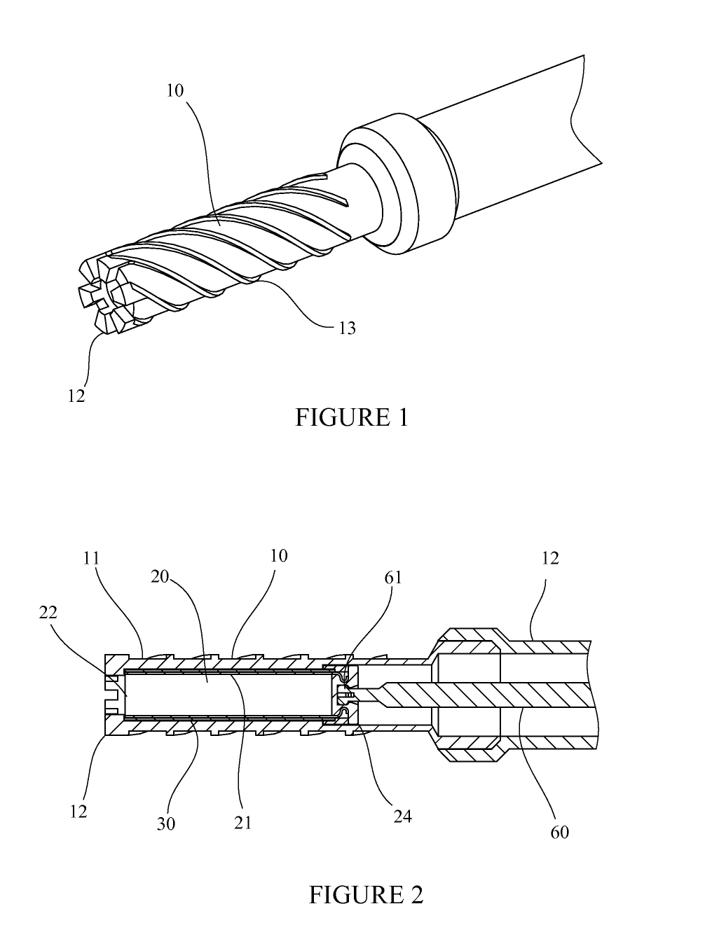

The methods, systems and components described herein relate to core sample encapsulation. The cores may comprise rock, soil, sand or other solids; and/or water, gas or other fluids. Core samples are generally obtained with a drill and core drill bit, but may be obtained by any number of sampling mechanisms and sampling tools. In one embodiment of the invention the sampling tool is a core drill bit 10, as in FIG. 1, which comprises a hollow tube 11, as in FIG. 2. The down-hole end of the tube may comprise one or more cutting teeth. In one embodiment of the invention the cutting teeth comprise a diamond embedded matrix and in other embodiments they comprise castellated carbide teeth 12. When drilled into a rock, ice or other sample the hollow tube creates an annular hole. The core sample is the portion of sample at the center of the annular hole. A variety of sampling mechanisms are suitable to obtain core samples. They include but are not limited to rotary drills, percussive drills, rotary percussive drills, ultrasonic drills and thermal drills. When a core drill bit rotates as for example with a rotary drill or a rotary-percussive drill, the core drill bit may comprise one or more flutes 13 on the outside surface of the drill bit to lift cuttings out of the drill hole.

Once an annular hole has been drilled to an acceptable depth the core sample is released from the parent material by breaking it off at the bottom of the hole. This can be accomplished by removing the drill bit and placing a different tool, for example a screwdriver, down the hole to break off the core. But some cores will have voids or loose material and this could cause the core to lose its original shape and/or stratigraphy when the core bit is removed.

In order to preserve core integrity it is advantageous to snap off and encapsulate the core sample while the core bit is still in the drill hole. In one embodiment of the invention the core bit comprises a groove in which a human operator can insert a tool, such as a screwdriver, to break off the core. In other embodiments the drill bit comprises an automated mechanism to break off the core, for example a break-off mechanism comprising inner and outer drill tubes with varying geometric relationships as described by Myrick in U.S. Pat. No. 6,550,549. This automated core break-off mechanism is especially valuable in robotic core drilling applications, such as with robotic planetary exploration. Once the core has been separated from its parent material the core can be encapsulated, though in some embodiments the core is encapsulated before the core has been separated.

In some embodiments a sample encapsulation device comprises an annular sample capsule 20, as in FIG. 2, located at the center of the drill bit 10. The sample capsule may take many shapes, but generally has a similar, albeit smaller, cross sectional shape as the drill bit. The sample capsule comprises a side wall 21, which is adjacent to the inside wall of the drill bit, and an open front end 22 toward the down-hole end of the drill bit. In some embodiments the opposite end or rear end of the capsule is closed.

When the sampling device, such as with a core drill, penetrates the material to be sampled the core slips into the sample capsule. The drill bit or other sampling tool must produce a core sample that is small enough to fit inside the sample capsule. A core drill bit will generally have cutting teeth 12 that are wide enough to produce such a sample.

When the core drill bit rotates, as for example with a rotary drill or a rotary-percussive drill, the sample capsule may be coupled to the drill bit or rotating drill mechanism and thus rotate with the drill bit. In other embodiments the sample capsule couples to the non-rotating portion of the drill and remains non-rotating while the drill bit rotates around it. In still other embodiments the sample capsule floats inside the drill bit and is free to rotate or not rotate depending upon the friction forces on the inside and outside surfaces of the capsule.

In some embodiment the side wall 21 of the sample capsule 20 comprises heat shrink tubing, which when activated (or heated to its activation temperature) shrinks to fit the contours of the sample. The heat shrink tubing may be manufactured from one of many plastics which are chosen for their application specific properties, such as for example, activation temperature, low friction, and abrasion resistance. Three suitable materials include Fluorinated Ethylene Propylene (FEP), Polytetrafluoroethylene (PTFE), and Polyetheretherketone (PEEK), though other materials may be used. The heat shrink tubing is activated and shrinks when its temperature is raised above a material specific value. The activation temperatures for PTFE and FEP are approximately 340° C. and 215° C. respectively, but may be more or less.

If the core samples will be analyzed for the presence of life it is advantageous to use heat shrink tubing made from a fluorinated polymer material, like for example PTFE or FEP. These materials are not easily confused with compounds created by living things as would a hydrocarbon based plastic like PEEK. In some embodiments the heat shrink tubing comprises a fluorinated polymer material.

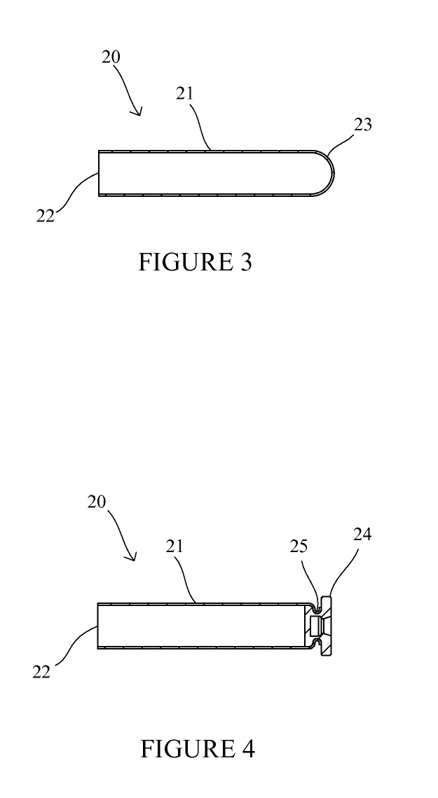

In some embodiments the sample capsule comprises heat shrink tubing which is closed at the rear end 23 of the capsule 20 as in FIG. 3. In other embodiments the heat shrink tubing is coupled to a rear end cap 24. In some embodiments the heat shrink tubing is bonded to a rear end cap 24 with an adhesive. In other embodiments the heat shrink tubing is shrunk on to the rear end cap 24. In even further embodiments the rear end cap 24 comprises a circumferential groove 25. The rear end cap 24 is inserted into the heat shrink tubing which is then heated locally in the vicinity of the groove 25. The shrink tubing shrinks to fit the groove 25 creating a retaining feature and seal between the side wall and the end cap 24. In further embodiments the heat shrink tubing is both adhesively bonded and shrunk to fit the rear end cap.

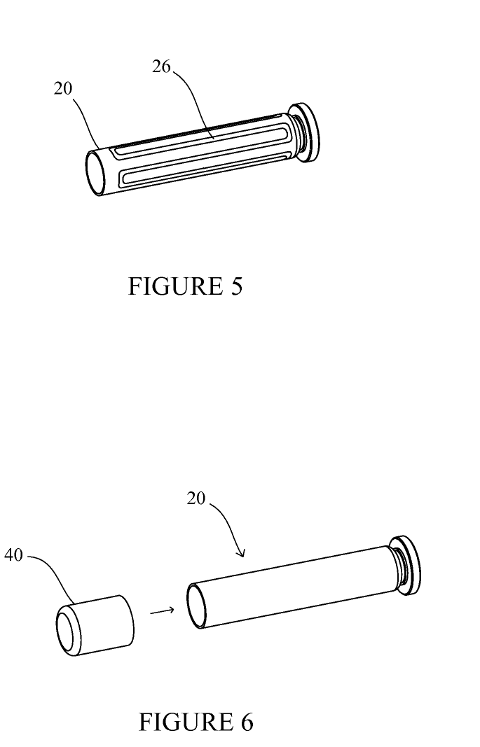

In some embodiments a sample encapsulation device comprises one or more heaters which when heated activate the heat shrink tubing. In one embodiment a heater is coupled to a sampling tool, for example a drill bit. In another embodiment, as in FIG. 5, one or more heating elements 26 are coupled to the sample capsule 20. In further embodiments a heater is located in the sampling mechanism, and may require a suitable means of communicating the heat to the heat shrink tubing, which may or may not include the drill bit itself.

In one embodiment the one or more heaters comprise an electrical film heater, examples of which are etched foil and wire wound heaters, though other types of heaters may be used. The selection of heater type will be coupled with the selection of heat shrink tubing material as the maximum operating temperature of the heater must be compatible with the activation temperature of the heat shrink tubing. Electrical connections can be made to the heater directly or via the drill, drill bit or sample tube. In one embodiment, illustrated in FIG. 2, the heater is an annular film heater 30 coupled to the inside wall of the drill bit. And the sample capsule is located inside the heater.

In some embodiments the invention comprises an element of thermal insulation between the heater and the drill bit to reduce the amount of power which is lost to heating the drill bit instead of heating the heat shrink tubing. The thermal insulation may, for example, comprise a material with low conductivity, a material with low emissivity or a physical gap. In some embodiments one or more of these forms of insulation may be used simultaneously.

In some embodiments the heat shrink tubing is activated after the drill bit has been extracted from the drill hole, and in other embodiments the tubing is activated while the drill bit is still in the drill hole. If the heat shrink tubing is activated when the core bit is still substantially inside the drill hole, the sample integrity may be immediately preserved. The heat shrink tubing shrinks to the contours of the core sample and may provide compression to keep loose material from moving around. Additionally, there is less chance that the sample will fall out of the drill bit as the drill bit is extracted from the hole.

Once the sample capsule has been removed from the drill bit, a front end cap 40 can then be placed on the sample capsule 20, as illustrated in FIG. 6. In some embodiments a front end cap 40 is placed on the sample capsule 20 and the front end cap 40 is coupled to the sample capsule 20. In one embodiment the front end cap 40 comprises a heat shrink cap which when activated shrinks to fit the sample capsule. In some embodiments the heat shrink cap includes an adhesive which bonds the front end cap 40 to the capsule 20.

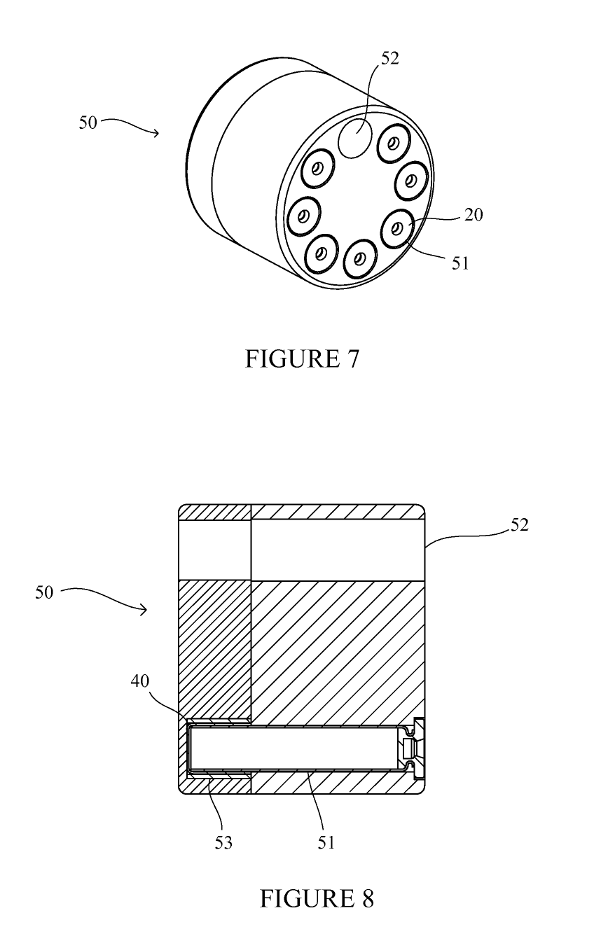

In autonomous sampling applications it is advantageous to have a sample caching mechanism such that multiple cores can be taken with the same drill. In some embodiments of the invention a sample caching mechanism 50, as illustrated in FIG. 7, comprises one or more chambers 51 for receiving a sample capsule 20. In other embodiments the cache also comprises one or more through-holes 52 for passing a sample capsule. The caching mechanism may comprise a means of attaching a front end cap to a sample capsule. In one embodiment of the invention, as illustrated in FIG. 8, each chamber 51 comprises a heater 53 and a heat shrink cap 40. After a sample capsule has been inserted in a chamber 51, activation of the heat shrink cap causes the sample capsule to be sealed.

The sample cache may be separate from the sampling mechanism or may be coupled to the sampling mechanism. In one embodiment the sample cache is located at the rear of a sampling mechanism, like for example a coring drill. The coring drill comprises a hollow drill tube, which passes entirely through the coring drill. The hollow drill tube communicates with the drill bit at one end and the cache at the other end. Behind the cache is a hollow antechamber in alignment with the drill tube. The cache contains one or more chambers and at least one through-hole. An actuation of the cache, for example a rotation of the cache, may cause a sample chamber or a through-hole to come into alignment with the drill tube and antechamber.

In one embodiment the cache mechanism comprises a plunger 60, as illustrated in FIG. 2, which may move back and forth through the antechamber, the cache and the drill tube via a linear drive mechanism. The plunger 60 is coupled to the rear of the sample capsule by a detent 61 or other suitable attachment mechanism which can be coupled and decoupled. When a through-hole of the cache is in alignment with the sampling tube, the plunger may pass entirely through the cache to place a sample capsule in the drill bit or to pull a sample capsule back through the drill tube and cache into the antechamber.

After a core has been drilled and the sample capsule activated, the plunger pulls the sample capsule back into the antechamber. The cache is then actuated, for example rotated, such that a chamber containing only a front end cap is in alignment with the antechamber. The plunger then pushes the sample capsule into the chamber containing the front end cap. A heater activates the heat shrink cap sealing the sample tube. In one embodiment the heat shrink cap is coupled to the chamber such that the plunger can now be decoupled from the sample tube. The plunger is withdrawn from the chamber and the cache is actuated until a chamber containing an empty sample capsule is in alignment with the plunger. The plunger couples to the empty sample capsule and withdraws it from the chamber pulling it into the antechamber. The cache actuates to align a through-hole with the antechamber. And finally the plunger pushes the empty sample capsule through the through-hole in the cache, down the drill tube and into the drill bit. In this way multiple cores can be drilled, encapsulated and cached.

### CONCLUSION

In the foregoing specification, various exemplary embodiments have been described. It will, however, be evident that various modifications and changes may be made thereto without departing from the broader spirit and scope of the invention which will be set forth in the claims. The specification and drawings are, accordingly, to be regarded in an illustrative rather than a restrictive sense.

What is claimed is:

1. A sample encapsulation device comprising:
a sampling tool, and;
a sample capsule located inside the sampling tool comprising an open front end and a side wall; the sample capsule further comprising heat shrink tubing;

2. The sample encapsulation device of claim 1, wherein the sampling tool is a core drill bit.

3. The sample encapsulation device of claim 2, wherein the core drill bit comprises castellated cutting teeth.

4. The sample encapsulation device of claim 2, wherein the core drill bit comprises one or more external flutes.

5. The sample encapsulation device of claim 1, wherein the heat shrink tubing is closed at the rear end.

6. The sample encapsulation device of claim 1, wherein the sample capsule comprises a rear end cap.

7. The sample encapsulation device of claim 6, wherein the rear end cap comprises a circumferential groove, and the heat shrink tubing conforms to the groove.

8. The sample encapsulation device of claim 1, additionally comprising a heater.

9. The sample encapsulation device of claim 8, wherein the heater is located inside the sampling tool.

10. The sample encapsulation device of claim 9, wherein the heater is an electrical film heater.

11. The sample encapsulation device of claim 9, wherein the heater activates the heat shrink tubing.

12. The sample encapsulation device of claim 9, additionally comprising an insulating element between the heater and the sampling tool.

13. A sample encapsulation device comprising:
a sampling tool;
a sample capsule located inside the sampling tool comprising an open front end and a side wall; the sample capsule further comprising heat shrink tubing, and;
a cache comprising one or more chambers;

14. The sample encapsulation device of claim 13, wherein the one or more chambers receive a sample capsule.

15. The sample encapsulation device of claim 14, wherein the one or more chambers comprise a front end cap.

16. The sample encapsulation device of claim 13, wherein the cache further comprises at least one through-hole.

17. The sample encapsulation device of claim 16, additionally comprising an antechamber and a plunger.

18. The sample encapsulation device of claim 17, wherein the plunger may couple and decouple with sample capsule.

19. A method of encapsulating a sample comprising:
providing a sample encapsulation device comprising:
a sampling tool;
a sample capsule located inside the sampling tool comprising an open front end and a side wall; the sample capsule further comprising heat shrink tubing, and;
a heater located inside the sampling tool;
collecting a sample inside the sample capsule, and;
heating the heat shrink tubing to encapsulate the sample.

20. The method of encapsulating a sample of claim 19, wherein the sampling tool is still in the parent material of the sample.
